(19) United States
(12) Patent Application Publication
(10) Pub. No.: US 2011/0258366 A1
(43) Pub. Date: Oct. 20, 2011

(54) STATUS INDICATION IN A SYSTEM HAVING A PLURALITY OF MEMORY DEVICES

(75) Inventors: Roland Schuetz, Ottawa (CA); HakJune Oh, Ottawa (CA); Hong Beom Pyeon, Ottawa (CA)

(73) Assignee: MOSAID Technologies Incorporated, Ottawa (CA)

(21) Appl. No.: 13/023,838

(22) Filed: Feb. 9, 2011

Related U.S. Application Data
(60) Provisional application No. 61/325,451, filed on Apr. 19, 2010.

(51) Int. Cl. G06F 12/00

(52) U.S. Cl. 711/103; 711/157; 711/E12.008

(57) ABSTRACT

Status indication in a system having a plurality of memory devices is disclosed. A memory device in the system includes a plurality of data pins for connection to a data bus. The memory device also includes a status pin for connection to a status line that is independent from the data bus. The memory device also includes first circuitry for generating, upon completion of a memory operation having a first duration, a strobe pulse of a second duration much shorter than the first duration. The strobe pulse provides an indication of the completion of the memory operation. The memory device also includes second circuitry for outputting the strobe pulse onto the status line via the status pin.

### CROSS REFERENCE TO RELATED APPLICATIONS

This application claims the benefit of priority of U.S. Provisional Patent Application Ser. No. 61/325,451 filed Apr. 19, 2010, which is incorporated herein by reference in its entirety.

### BACKGROUND OF THE DISCLOSURE

Computers and other information technology systems typically contain semiconductor devices such as memory. The semiconductor devices are controlled by a controller, which may form part of the central processing unit (CPU) of a computer or may be separate therefrom. The controller has an interface for communicating information to and from the semiconductor devices. Also, it will be understood that the types of information that might be communicated, and the various implementations disclosed in the prior art for carrying out such controller-device communications are numerous. Ready or busy status of the memory device is an example of just one type of information that might be communicated from a memory device to a controller.

### SUMMARY

It is an object of the invention to provide an improved system that includes one or more memory devices.

According to one aspect of the invention, there is provided a system that includes a plurality of devices, each of the plurality of devices including a status input pin, a status output pin, and separate data input and output pins. The plurality of devices includes a plurality of semiconductor memory devices including at least first and last memory devices. The plurality of devices also includes a controller device for communicating with the semiconductor memory devices. The first memory device has a status input pin connected to a status output pin of the controller device. A status output pin of the first memory device is connected to a status input pin of either an intervening memory device or the last memory device. The status input pin of the last memory device is connected to a status output pin of either another intervening memory device, the intervening memory device or the first memory device. A status output pin of the last memory device is connected to a status input pin of the controller so that a status ring is formed. Each of the plurality of devices is on the status ring, and the status ring provides a status communications path that is independent of any data communications path between any of the plurality of semiconductor memory devices and the controller device.

According to another aspect of the invention, there is provided a memory device that includes a plurality of data pins for connection to a data bus. The memory device also includes a status pin for connection to a status line that is independent from the data bus. The memory device also includes first circuitry for generating, upon completion of a memory operation having a first duration, a strobe pulse of a second duration much shorter than the first duration. The strobe pulse provides an indication of the completion of the memory operation. The memory device also includes second circuitry for outputting the strobe pulse onto the status line via the status pin.

According to yet another aspect of the invention, there is provided a method that includes providing a flash memory device that includes a plurality of data pins and a status pin, the plurality of data pins being connected to a data bus, and the status pin being connected to a status line that is independent from the data bus. The method also includes carrying out, within the flash memory device, a memory operation having a first duration. The method also includes generating, upon completion of the memory operation, a strobe pulse of a second duration much shorter than the first duration, and the strobe pulse providing an indication of the completion of the memory operation. The method also includes outputting the strobe pulse onto the status line via the status pin.

Thus, an improved system that includes one or more memory devices has been provided.

### BRIEF DESCRIPTION OF THE DRAWINGS

Reference will now be made, by way of example, to the accompanying drawings:

FIG. 1A is a block diagram of an example system that receives a parallel clock signal;

FIG. 1B is a block diagram of an example system that receives a source synchronous clock signal;

FIG. 2 is a block diagram of a system in accordance with an example embodiment, each device in the ring of devices including an additional set of 10 pins for providing an independent status ring;

FIG. 3 is a block diagram of a system in accordance with an alternative example embodiment, each device in the ring of devices including an additional set of IO pins for providing an independent status ring;

FIG. 4 is a diagram of a status packet in accordance with an example embodiment;

FIG. 5 is a diagram of a status packet in accordance with an alternative example embodiment;

FIG. 6 is a diagram of a status packet in accordance with an yet another alternative example embodiment;

FIG. 7 is a timing diagram in accordance with some example embodiments;

FIG. 8 is a block diagram of an example status bus controller that may be included in memory devices in accordance with example embodiments;

FIG. 9 is another timing diagram in accordance with some example embodiments; and

FIG. 10 is another timing diagram in accordance with some example embodiments;

FIG. 11 is another timing diagram in accordance with some example embodiments;

FIG. 12 is a block diagram of a system in accordance with yet another alternative example embodiment;

FIGS. 13A and 13B are another timing diagram in accordance with some example embodiments;

FIG. 14 is another timing diagram in accordance with some example embodiments; and

FIGS. 15A and 15B are yet another timing diagram in accordance with some example embodiments.

Similar or the same reference numerals may have been used in different figures to denote similar example features illustrated in the drawings.

### DETAILED DESCRIPTION OF EXAMPLE EMBODIMENTS

Examples of systems having ring-type topologies are described in US patent application publication No. 2008/0201548 A1 entitled “SYSTEM HAVING ONE OR MORE MEMORY DEVICES” which was published on Aug. 21, 2008, U.S. Patent Application Publication No. 2008/0049505 A1 entitled “SCALABLE MEMORY SYSTEM” which was published on Feb. 28, 2008, US patent application publication No. 2008/0052449 A1 entitled “MODULAR COMMAND STRUCTURE FOR MEMORY AND MEMORY SYSTEM” which was published on Feb. 28, 2008, US patent application publication No. 2010/0091536 A1 entitled “COMPOSITE MEMORY HAVING A BRIDGING DEVICE FOR CONNECTING DISCRETE MEMORY DEVICES TO A SYSTEM” which was published on Apr. 15, 2010. At various points in the description that follows, references may be made to certain example command, address and data formats, protocols, internal device structures, and/or bus transactions, etc., and those skilled in the art will appreciate that further example details can be quickly obtained with reference to the above-mentioned patent references.

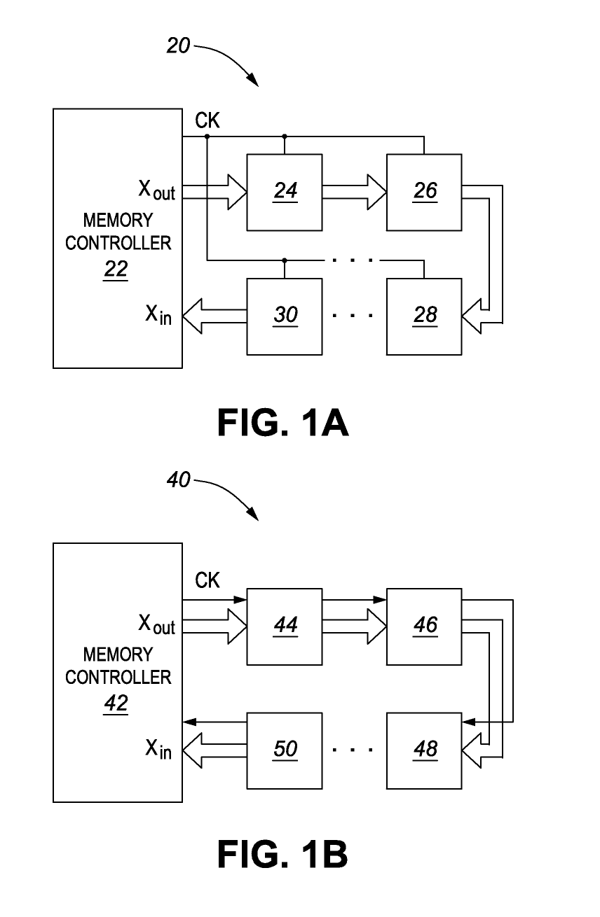

In accordance with some example embodiments, command packets originate from a controller and are passed around a ring of memory devices, through each memory device in a point-to-point fashion, until they end up back at the controller. FIG. 1A is a block diagram of an example system that receives a parallel clock signal while FIG. 1B is a block diagram of the same system of FIG. 1A receiving a source synchronous clock signal. The clock signal can be either a single ended clock signal or a differential clock pair.

In FIG. 1A, the system 20 includes a memory controller 22 having at least one output port Xout and an input port Xin, and memory devices 24, 26, 28 and 30 that are connected in series. While not shown in FIG. 1A, each memory device has an Xin input port and an Xout output port. Input and output ports consist of one or more physical pins or connections interfacing the memory device to the system it is a part of. In some instances, the memory devices are flash memory devices. The current example of FIG. 1A includes four memory devices, but alternate examples can include a single memory device, or any suitable number of memory devices. Accordingly, if memory device 24 is the first device of the system 20 as it is connected to Xout, then memory device 30 is the Nth or last device as it is connected to Xin, where N is an integer number greater than zero. Memory devices 26 to 28 are then intervening serially connected memory devices between the first and last memory devices. Each memory device can assume a distinct identification (ID) number, or device address (DA) upon power up initialization of the system, so that they are individually addressable. Commonly owned U.S. patent application Ser. No. 11/622,828 titled “APPARATUS AND METHOD FOR PRODUCING IDS FOR INTERCONNECTED DEVICES OF MIXED TYPE”, U.S. patent application Ser. No. 11/750,649 titled “APPARATUS AND METHOD FOR ESTABLISHING DEVICE IDENTIFIERS FOR SERIALLY INTERCONNECTED DEVICES”, U.S. patent application Ser. No. 11/692,452 titled “APPARATUS AND METHOD FOR PRODUCING DEVICE IDENTIFIERS FOR SERIALLY INTERCONNECTED DEVICES OF MIXED TYPE”, U.S. patent application Ser. No. 11/692,446 titled “APPARATUS AND METHOD FOR PRODUCING IDENTIFIERS REGARDLESS OF MIXED DEVICE TYPE IN A SERIAL INTERCONNECTION”, U.S. patent application Ser. No. 11/692,326 titled “APPARATUS AND METHOD FOR IDENTIFYING DEVICE TYPE OF SERIALLY INTERCONNECTED DEVICES”, U.S. patent application Ser. No. 11/771,023 titled “ADDRESS ASSIGNMENT AND TYPE RECOGNITION OF SERIALLY INTERCONNECTED MEMORY DEVICES OF MIXED TYPE” and U.S. patent application Ser. No. 11/771,241 titled “SYSTEM AND METHOD OF OPERATING MEMORY DEVICES OF MIXED TYPE” describe methods for generating and assigning device addresses for serially connected memory devices of a system.

Memory devices 24 to 30 are considered serially connected because the data input of one memory device is connected to the data output of a previous memory device, thereby forming a series-connection system organization, with the exception of the first and last memory devices in the chain. The channel of memory controller 22 includes data, address, and control information provided by separate pins, or the same pins, connected to conductive lines. The example of FIG. 1A includes one channel, where the one channel includes Xout and corresponding Xin ports. However, memory controller 22 can include any suitable number of channels for accommodating separate memory device chains. In the example of FIG. 1A, the memory controller 22 provides a clock signal CK, which is connected in parallel to all the memory devices.

In general operation, the memory controller 22 issues a command through its Xout port, which includes an operation code (op code), a device address, optional address information for reading or programming, and data for programming. The command may be issued as a serial bitstream command packet, where the packet can be logically subdivided into segments of a predetermined size. Each segment can be one byte in size for example. A bitstream is a sequence or series of bits provided over time. The command is received by the first memory device 24, which compares the device address to its assigned address. If the addresses match, then memory device 24 executes the command. The command is passed through its own output port Xout to the next memory device 26, where the same procedure is repeated. Eventually, the memory device having the matching device address, referred to as a selected memory device, will perform the operation specified by the command. If the command is a read data command, the selected memory device will output the read data through its output port Xout (not shown), which is serially passed through intervening memory devices until it reaches the Xin port of the memory controller 22. Since the commands and data are provided in a serial bitstream, the clock is used by each memory device for clocking in/out the serial bits and for synchronizing internal memory device operations. This clock is used by all the memory devices in the system 20.

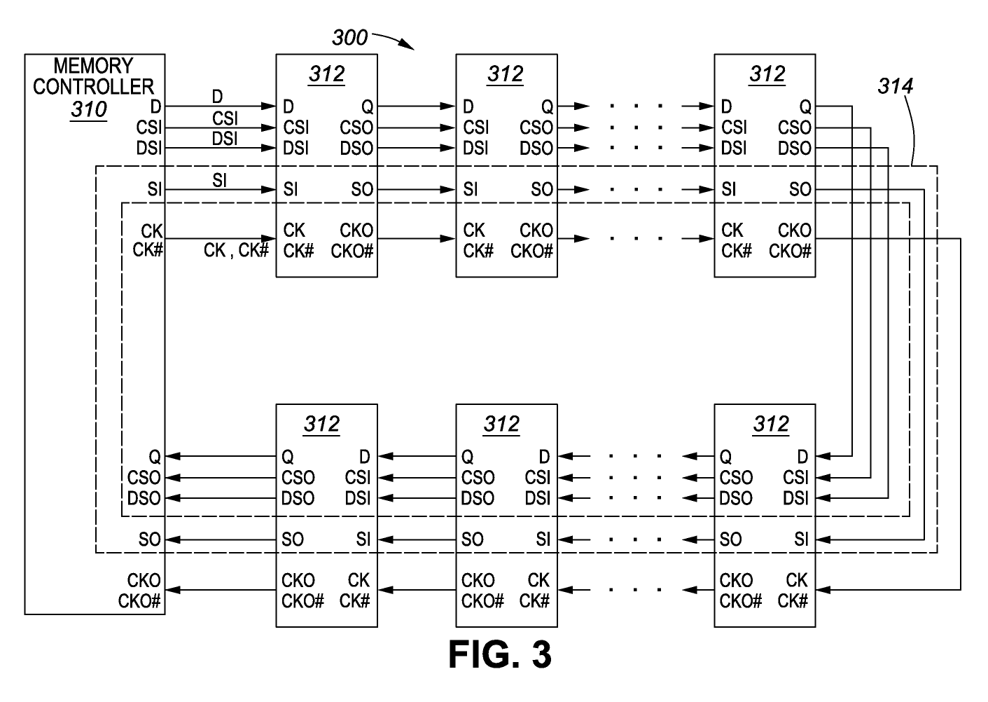

Further details of a more specific example of the system 20 of FIG. 1A are provided in FIG. 3A and paragraphs 53-56 of the previously mentioned US patent application publication No. 2008/0201548 A1, and this figure and corresponding paragraphs of description are herein incorporated by reference.

Because the clock frequency used in the system according FIG. 1A is relatively low, unterminated full swing CMOS signaling levels can be used to provide robust data communication. This is also referred to as LVTTL signaling, as should be well known to those skilled in the art.

A further performance improvement over the system 20 of FIG. 1A can be obtained by the system of FIG. 1B. System 40 of FIG. 1B is similar to the system 20 of FIG. 1A, except that the clock signal CK is provided serially to each memory device from an alternate memory controller 42 that provides the source synchronous clock signal CK. Each memory device 44, 46, 48 and 50 may receive the source synchronous clock on its clock input port and forward it via its clock output port to the next device in the system. In some examples of the system 40, the clock signal CK is passed from one memory device to another via short signal lines. Therefore none of the clock performance issues related to the parallel clock distribution scheme are present, and CK can operate at high frequencies. Accordingly, the system 40 can operate with greater speed than the system 20 of FIG. 1A. For example, high speed transceiver logic (HSTL) signaling can be used to provide high performance data communication. In the HSTL signaling format, each memory device may receive a reference voltage that is used for determining a logic state of the incoming data signals. Another similar signaling format is the SSTL signaling format. Accordingly, the data and clock input circuits in the memory devices of the systems 20 and 40 are structured differently from each other. Both the HSTL and SSTL signaling formats should be well known to those skilled in the art.

Further details of a more specific example of the system 40 of FIG. 1B are provided in FIG. 3B and paragraphs 57-58 of the previously mentioned US patent application publication No. 2008/0201548 A1, and this figure and corresponding paragraphs of description are herein incorporated by reference.

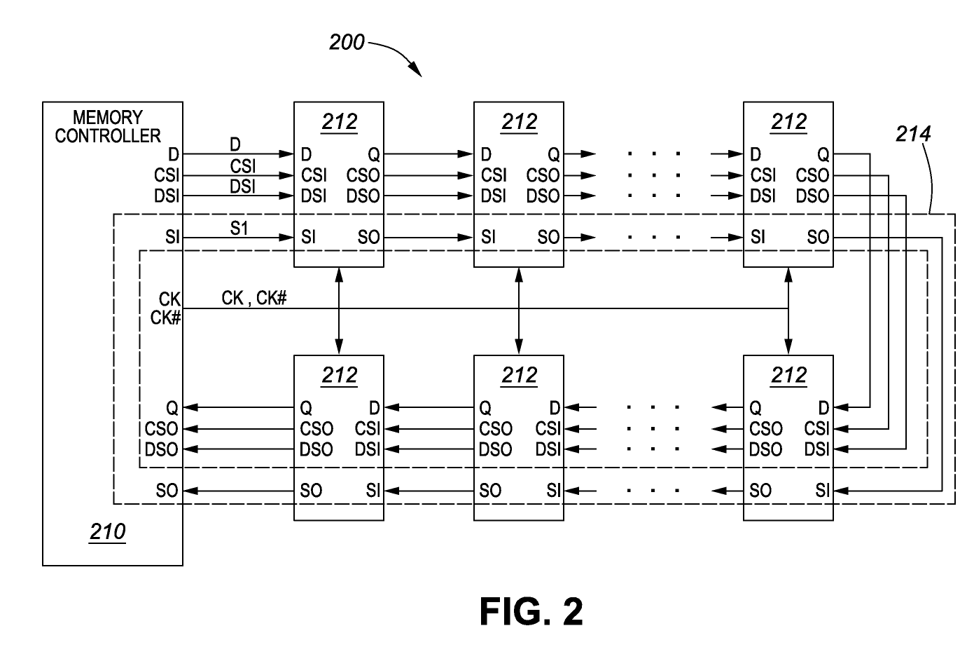

Reference will now be made to FIG. 2. FIG. 2 is a block diagram of a system 200 in accordance with an example embodiment, the illustrated system including a memory controller 210 and a plurality of memory devices 212. The illustrated system may, in many respects, be similar to the system of FIG. 1A, with Xout and Xin ports being diagrammatically illustrated in more granular detail by a plurality of lines, one of which is a status line which extends from device to device around the ring of devices, each of which include an additional set of IO pins (i.e. additional to the DQ pins) for providing an independent status ring 214. These additional IO pins are labeled SI and SO on the memory controller 210 and each of the memory devices 212. The SI pin and the SO pin are also herein referred to as the status input pin and the status output pin respectively.

Referring now to FIG. 3, there is a block diagram of a system 300 in accordance with an alternative example embodiment, the illustrated system including a memory controller 310 and a plurality of memory devices 312. The difference between the system 300 and the system 200 is mainly just that the system 300 employs the serially distributed clock as described in connection with FIG. 1B, and that being the main difference it will be convenient to now discuss subsequent details with reference to both example embodiments.

In accordance with the example embodiments of FIGS. 2 and 3, the general operation is as follows. When a memory device 212 or 312 has completed an internal operation such as program, read, erase, etc., it updates its status register with information about the completed operation. Once it has completed updating its status register, the memory device may automatically transmit the contents of its status register over the status ring 214 or 314 back to the controller 210 or 310, thereby notifying the controller 210 or 310 that an outstanding operation has completed. This automatic transferring of status to the controller alleviates the burden on the controller to keep track of the progress of outstanding memory operations. Each memory device 212 or 312 is responsible for notifying the controller 210 or 310 when it has completed an operation.

A purpose of the status ring 214 or 314 is thus to allow for the transfer of status information without adding to the overhead of the command and data bus. In particular, for conventional memory systems the host (for example, the controller) learns the status of the memory devices in one of two ways: i) by a Ready/Busy pin, generally called RBb, which alerts the controller as to when internal operations have been completed in the memory device (in some less complex implementations, the RBb pins of all memory chips are tied together, so that a “Busy” signal on the common line cannot by itself indicate whether any one particular device is ready or busy, with the disadvantage being that during a “Busy” period the controller may have to find out some other way whether one particular device is ready); and ii) ‘Read Status Register’ command where the contents of the memory device's status register are transmitted to the controller over the command/data bus. Each memory device may be equipped with a unique RBb pin which is connected to the controller so that the controller can easily interpret which device is Ready and which one is Busy with internal operations. In memory devices connected in a ring architecture, such as the example ring architecture shown in FIG. 1A or 1B, the status gathering functions may be built into the protocol of the bus and there is no additional Ready/Busy pin. This is done as a means of saving on pin count especially when connecting a large number of devices on each ring, or channel. With one Ready/Busy pin per device, the number of pins increases linearly with device count and can result in unworkable pin-counts over a ring or memory sub-system. Therefore, the status information, including Ready/Busy, is incorporated into the protocol of the command/data bus.

However, as traffic over the memory channel becomes busier, the overhead associated with collecting status and Ready/Busy information can become large enough so as to no longer be considered negligible when compared to the data page transfer size (which is may be, for example, 4 KB or 8 KB). Also, it becomes a challenge for the controller to interleave all of the necessary status commands onto the bus between command and data packets in a timely manner. This problem may be avoided for the example embodiments of FIGS. 2 and 3. In these embodiments status commands and information do not need to travel along the data communications path that includes the lines that extend between command/data input and output pins (D and Q pins). Instead of shared lines for both data and status communications, the system 200 (or the system 300) includes a status ring that provides an independent status communications path.

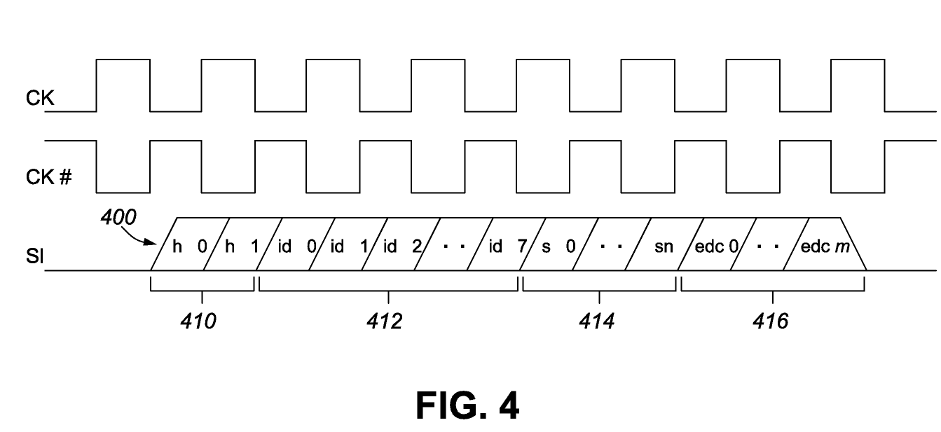

Reference will now be made to FIG. 4. FIG. 4 is a diagram of a status packet 400 in accordance with an example embodiment. In accordance with some example embodiments, status packets are small so that they do not occupy much time on the bus and so that the controller can decode them with a minimum of logic and processing overhead. In some examples, status packets begin with some header bits 410 to identify the start of the packet, and contain the sender's device identity (bits 412 in FIG. 4) along with the relevant status bits 414 and, finally, an Error Detection Code (EDC) value of length m+1 (bits 416 in FIG. 4). As an alternative to EDC, a status packet in accordance with example embodiments of FIG. 4 and some later described figures may include Error Correction Code (ECC) bits. As appreciated by those skilled in the art, ECC implies both error detection and correction within the controller of the system, whereas EDC implies that the controller can detect (but not correct) the error. Also, it is noted that status packets may optionally be transmitted and received in DDR format.

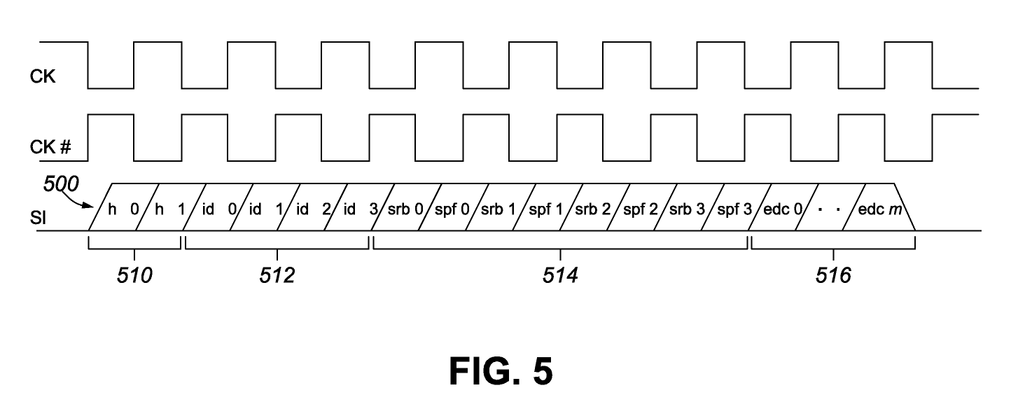

In accordance with some example embodiments, the contents of the status packet are programmable in order to tailor the packet characteristics to the rings in a particular memory subsystem. This may be achieved via control registers. For example, if a memory subsystem has rings containing only fifteen devices per ring, the controller may configure the packet to contain only four bits of device ID (id0-id3) which is all that would be necessary. Additionally, if each memory device contained four banks with one plane per bank, the controller could configure the status bits to contain only the four corresponding Ready/Busy bits (srb0-srb3) and four Pass/Fail bits (spf0-spf3) and leave out other status bits relating to those banks The decision would thus be made to treat Ready/Busy and Pass/Fail as the most important bits for general operation of the memory device. A status packet configured as described above is shown in FIG. 5. Illustrated example status packet 500 comprises the above described bits, namely header bits 510, id0-id3 bits 512, Ready/Busy and Pass/Fail bits 514 and EDC bits 516.

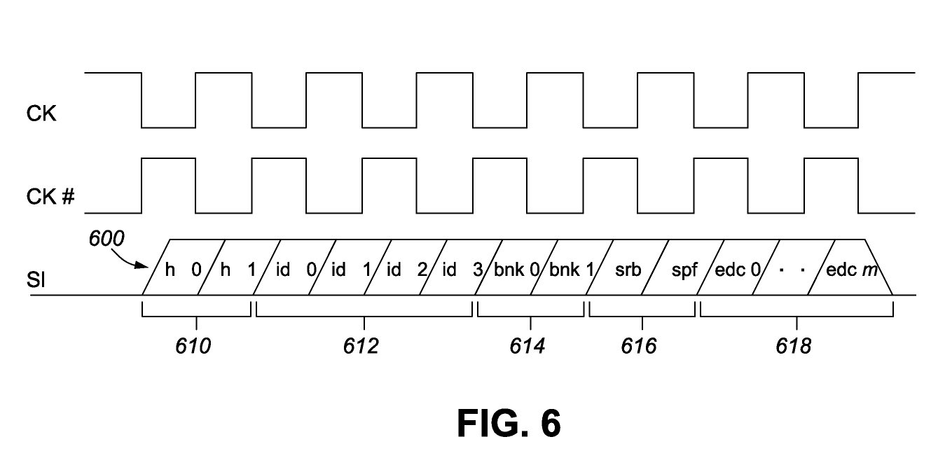

Further packet size reduction can be achieved in those systems that limit status events to one status event at a time. In such systems, the status packet includes only a subset of Ready/Busy and Pass/Fail information, namely only the Ready/Busy and Pass/Fail information of the bank that has completed an internal operation. Also, in such circumstances the controller would still need to identify the owner of those status bits, so therefore the packet would additionally have to be configured to contain two bank bits for bank identification. The status packet is thus reduced in size by an additional four bits in this example case. A status packet configured as described above is shown in FIG. 6. Illustrated example status packet 600 comprises the above described bits, namely header bits 610, id0-id3 bits 612, bank bits 614, Ready/Busy and Pass/Fail bits 616 and EDC bits 618.

In accordance with some example embodiments, if the controller requires status information that it has not configured the status packets to contain, it may do so via the normal data and command bus. This should not adversely affect the performance of the data and command bus by adding undue overhead, because such supplementary status reads would be expected to be few and to occur infrequently.

The header may be any suitable length. The most efficient length in terms of packet length would be only one bit wide; however in some alternative examples two bits set to logic ‘1’ may constitute the header. Other header lengths or data patterns may be possible.

In order to support proper functioning of the status bus of at least some example embodiments, each memory device is equipped with a controller, programmable delay logic, and control registers. These will be described in more detail later.

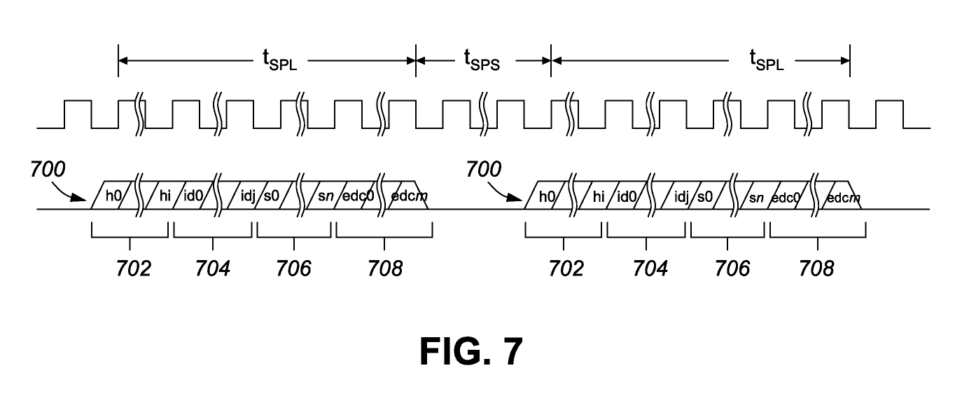

Reference will now be made to FIG. 7. FIG. 7 is a timing diagram showing the composition of example status packets 700 and two timing parameters that need to be worked into the design of the status bus controller in accordance with some example embodiments. Status packets 700 in the illustrated example are received starting on the positive edge of the Ck, and contain a new bit every edge of Ck, in DDR fashion. The composition of the status packet includes, but is not limited to, i+1 header bits 702, j+1 device ID bits 704, k+1 bank bits (not shown in this particular figure for convenience of illustration), n+1 status bits 706, and m+1 EDC bits 708 The length of the status packet is given by tSPL which is given by: tSPL=½ tCK*(i+j+k+n+m+5); where tCK is the clock period of the system bus (but may be a unique and independent clock provided for the status bus alone). Each status packet 700 is separated by a given number of positive clock edges as determined by the particular implementation. This separation is called Status Separation Latency and is given by tSPS in FIG. 7. Some designs may require more, and some may require only one clock edge (i.e. either one positive clock edge, or alternatively one negative clock edge).

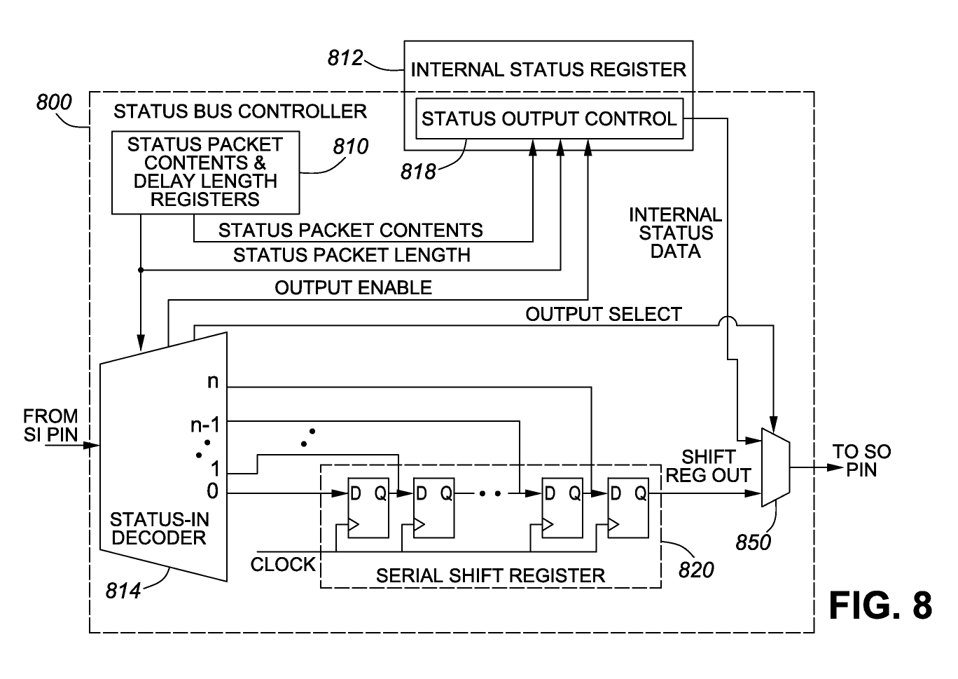

Referring now to FIG. 8, there is diagrammatically illustrated an example status bus controller 800 that may be included in each memory device 212 (FIG. 2) or memory device 312 (FIG. 3). The illustrated status bus controller 800 includes status packet contents and delay length registers 810. During system operation, the host (for example, the controller) programs the registers 810 with the composition (or features) of the status packet. The registers 810 also contains the final length of the status packet and is coupled to the memory's internal status register 812 and a Status-In Decoder 814. The internal status register 812 contains Status Output Control circuitry 818 that is responsible for shifting out the status packet including header bits, device ID bits, bank bits, status bits, EDC bits and any other bits that the packet is configured to contain. The inputs to the Status Output Control circuitry 818 are: i) Status Packet Contents (so that the Status Output Control circuitry 818 can ascertain which status bits to include); ii) Status Packet length (employed by the Status Output Control circuitry 818 for control purposes); and iii) Output Enable (so that the Status Output Control circuitry 818 can ascertain when it may shift out an internal status packet).

Still with reference to FIG. 8, the Status-In Decoder 814 gates incoming status packets to a serial shift register 820 via a tap line that corresponds to the length of the status packet. It is the Status Packet Length signal from the Delay Length portion of the registers 810 that determines which tap of the serial shift register 820 is chosen. For example, when the host (for example, the controller) configures the contents of the status packet by programming the Status Packet Contents portion of the registers 810, the length is computed and stored in the Delay Length portion of the registers 810. This value is used to select which tap is used to load the serial shift register 820. The purpose of the serial shift register 820 is to add sufficient delay to the incoming status packet so that a possible outgoing status packet from the internal status register 812 may be completed prior to the incoming packet reaching the SO output pin.

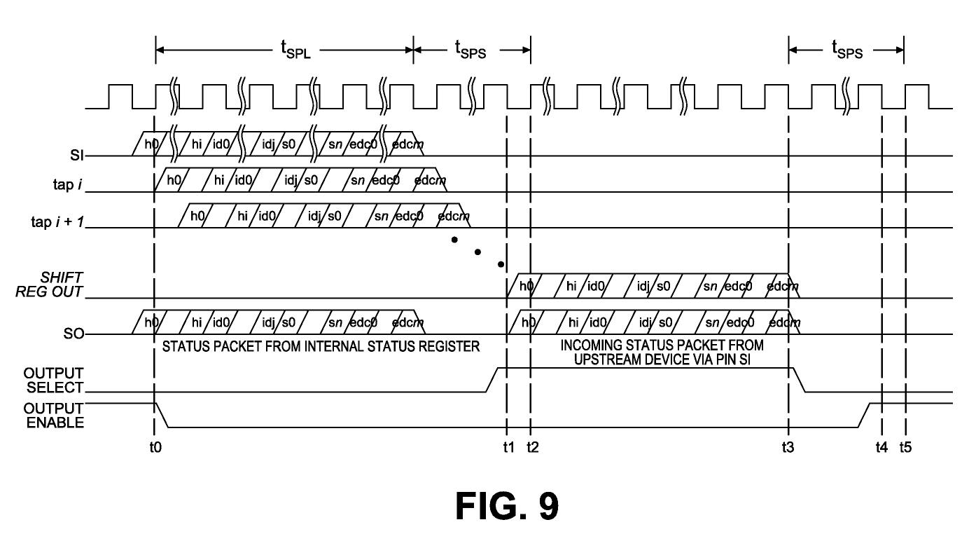

Reference will now be made to FIG. 9. FIG. 9 is a timing diagram showing an example status packet passing through a memory device. It arrives on pin SI at t0, travels through the shift register, and then is driven out on the SO pin at t1. The Status-In Decoder 814 (FIG. 8) generates signal Output Select that causes output mux 850 (FIG. 8) to select the shift register output for transmission to the SO pin. The Status-In Decoder 814 knows the length of the status packet, the delay through the shift register and tSPS, and therefore it knows when and for how long to drive Output Select logic high to select the pass-through status packet so that it arrives at the next device in the ring at t2. When the last bit of the pass-through status packet is driven out on the SO pin (shown at t3) the signal Output Select may be de-asserted to allow internal status packets access to the output pin.

If it detects a pass-through status packet on SI, the Status Bus Controller 800 (FIG. 8) should not drive out an internal status packet. As shown in FIG. 9, an internal status packet is driven out beginning at t0. At approximately this same time, a new pass-through packet is detected on SI. Therefore, this is the last clock cycle for beginning the output of an internal status packet. The Status-In Decoder 814 (FIG. 8) generates a signal Output Enable that tells the Status Output Control circuitry 818 (FIG. 8) when it is okay to drive out new packets. In one example, logic high for this signal means ‘it is okay to drive out an internal status packet’, and logic low means ‘do not drive out new internal status packet’. The other logic sense is possible too. When the Status Output Control circuitry 818 detects a logic low, it may not drive out a new internal status packet but may complete driving out the entirety of a packet that is currently in progress. The serial shift register 820 provides enough delay so that the internal status packet and pass-through status packet do not collide at the output pin and so that all timing parameters, like tSPS, are observed. In FIG. 9, the signal Output Enable goes logic high so that the memory device may drive an internal status packet out at t4 in order that it may arrive at the next down-stream device at t5.

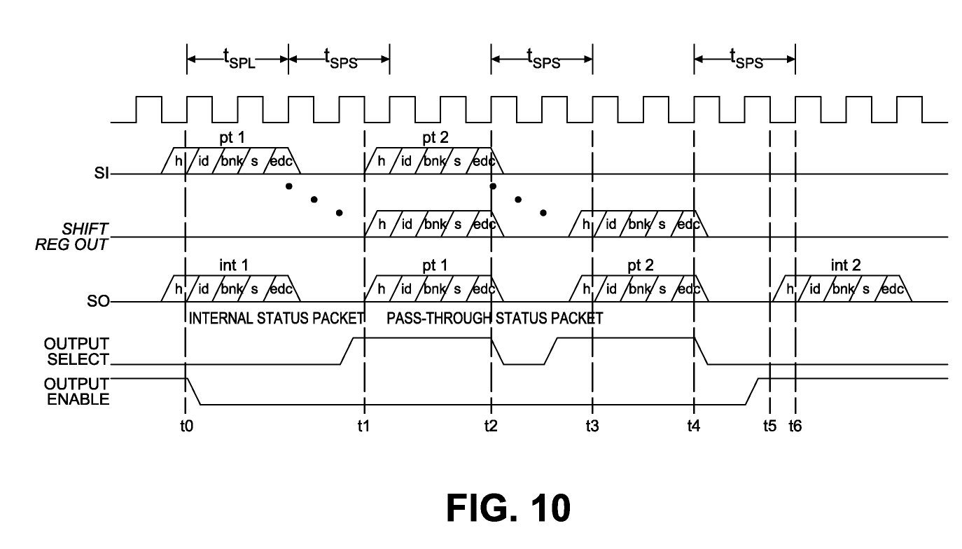

Reference will now be made to FIG. 10. FIG. 10 is a timing diagram showing arbitration between a number of pass-through and internal status packets in accordance with an example embodiment. An internal status packet int1 is driven out starting at t0. This is the same time that a new pass-through packet is received on SI. Output Enable is then de-asserted to prevent new internal packets from being driven out but allows the packet in progress, int1, to be completed. Later Output Select is driven high in order that pass-through packet may be driven out on SO at t1. At t1, a new pass-through packet arrives at SI. At t2 packet pt1 has been driven out so Output Select is de-asserted. Since the new packet pt2 was received at t1, Output Enable for new internal packets could not be re-asserted at t3. Instead, Output Select is re-asserted in order to drive out the pass-through packet pt2, which is next in the shift register. At t4, packet pt2 is completed and Output Select is de-asserted. Then, at t5, Output Enable is re-asserted in order to allow for the new internal status packet, int2, to be driven out and received by the subsequent device in the ring at t6.

Other variations on implementing status indication within the systems of FIG. 2 or 3 are contemplated. For example, a simple asynchronous-type implementation as described below is one alternative example embodiment. In this alternative example embodiment, any of the memory devices 212 or 312 can, upon the completion of certain internal operations (for example, page read, page program, block erase, operation abort, etc.) issue a single strobe pulse, on the status ring 214 or 314, to notify the controller 210 or 310 of the completion of the operation. The issuance of a single strobe pulse is not however necessarily limited to only those instances where some operation has been completed, rather more generally the single strobe pulse is intended to provide an indication of some form of status change within a memory device. Also, it is contemplated that memory devices in accordance with example embodiments may each comprise circuitry for generating strobe pulses, as well as circuitry for outputting strobe pulses.

In at least some asynchronous-type implementations, the status pulse contains no detailed information about the identity of the issuing memory device, so the controller 210 or 310 may learn the identity of the issuing memory device by, for example, broadcasting a Read Status Register command around the ring of devices. Each memory device 212 or 312 in the ring of devices receives the Read Status Register command on its respective CSI pin, processes the command and forwards it to the next downstream memory device which in turn handles the Read Status Register command in a likewise manner. During this process, each of the memory devices 212 or 312 appends it respective status information to a status packet transmitted out on the Q output pins of the memory device. Once the status packet arrives back at the controller 210 or 310, the status packet can be processed to obtain a determination of which memory device has completed an operation and whether that operation was successfully completed (or failed). In some examples, it may be possible for the controller to reduce the bus usage overhead associated with these Read Status Register commands by not always immediately broadcasting a Read Status Register command, but rather waiting until for some number (i.e. number greater than one) of status pulses to be received before broadcasting a Read Status Register command.

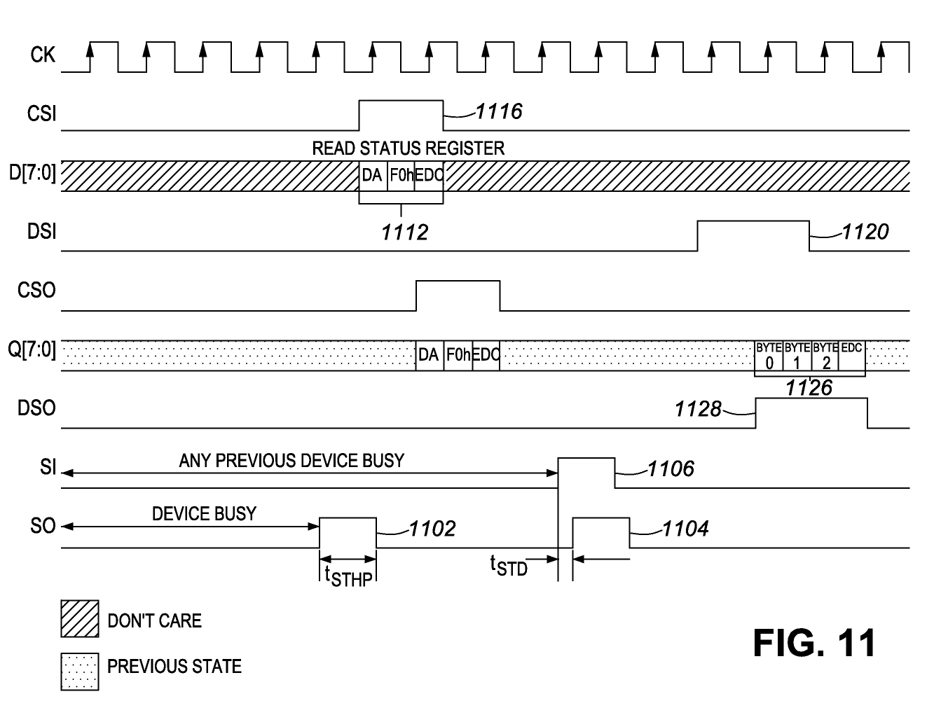

The above described alternative example embodiment will be understood in further detail with reference to the timing diagram in FIG. 11. In this timing diagram, status pulse 1102 on the SO output is issued not by a first memory device, but rather by a second or subsequent downstream memory device in either the system 200 or 300 (FIG. 2 or 3). The status pulse 1102 has the minimum pulse width denoted by t_{STHP}. Also shown in the timing diagram is a similar status pulse 1104, but the status pulse 1104 is different from the status pulse 1102 because it originated from an upstream memory device as evidenced by earlier-in-time version 1106 of the status pulse on the SI input. A minimum propagation delay between the versions of the pulse is denoted by t_{STD}.

Also shown diagrammatically in FIG. 11 is a Read Status Register command denoted by reference numeral 1112. The Read Status Register command 1112 includes a device address byte ‘DA’, and hence it is different than the Read Status Register command previously described in that it is directed to a specific memory device as opposed to being broadcast to all memory devices. Thus it is noted that in some instances a memory controller may only want to know status information of a particular memory device instead of all memory devices. The Read Status Register command also includes the ‘F0h’ byte indicating the command type ('F0h' is just by way of example and any other suitable byte is contemplated). The Read Status Register command also includes an error correction byte denoted by ‘EDC’. A number of clock cycles later after a command input strobe 1116 becomes de-asserted, a data input strobe 1120 becomes asserted to prime the memory device for transmission of a status packet denoted by reference numeral 1126 out on the Q pins of the memory device. A data output strobe 1128 delineates a length of the status packet 1126.

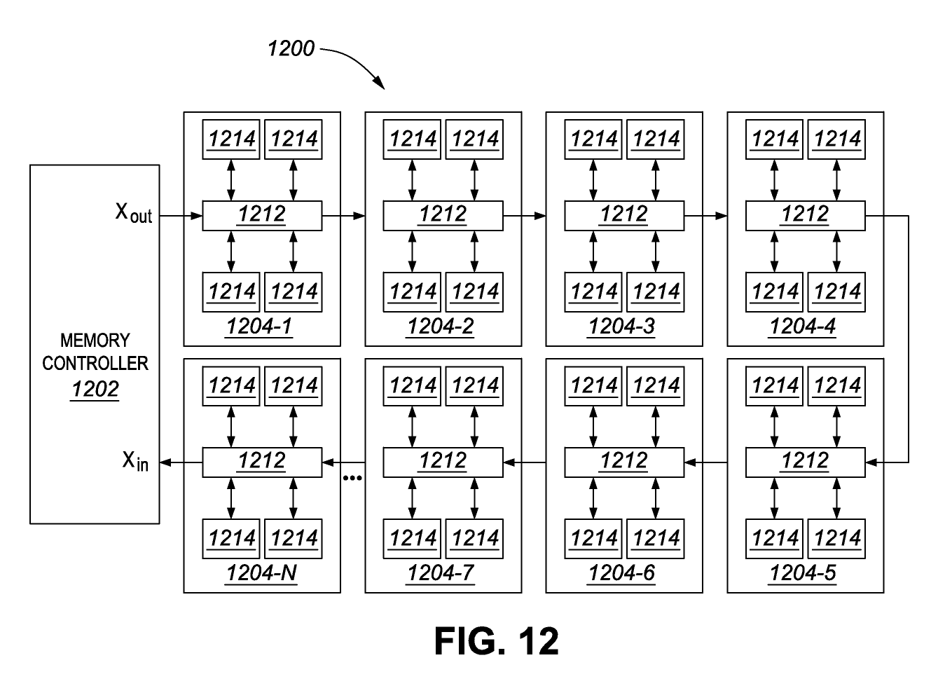

Systems in accordance with example embodiments are not limited to those shown in FIGS. 2 and 3. Another alternative system 1200 is shown in FIG. 12. This alternative system will be presently described in somewhat general terms; however more extensive example implementation details can be found in commonly owned U.S. patent application Ser. No. 12/401,963 titled “COMPOSITE MEMORY HAVING A BRIDGING DEVICE FOR CONNECTING DISCRETE MEMORY DEVICES TO A SYSTEM”, U.S. patent application Ser. No. 12/508,926 titled “BRIDGING DEVICE HAVING A CONFIGURABLE VIRTUAL PAGE SIZE”, and U.S. patent application Ser. No. 12/607,680 titled “BRIDGE DEVICE HAVING A VIRTUAL PAGE BUFFER”, all of these three applications being herein incorporated by reference in their entireties.

The system 1200 of FIG. 12 is similar to the systems of FIGS. 2 and 3, but with important differences. System 1200 includes a memory controller 1202 and composite memory devices 1204-1 to 1204-N, where N is an integer number. The individual composite memory devices 1204-1-1204-N are serially interconnected with the memory controller 1202. Similar to systems of FIGS. 2 and 3, composite memory device 1204-1 is the first composite memory device of memory system 1200 as it is connected to an output port Xout of memory controller 1202, and memory device 1204-N is the last device as it is connected to an input port Xin of memory controller 1202. Composite memory devices 1204-2 to 1204-7 are then intervening serially connected memory devices connected between the first and last composite memory devices. The Xout port provides a global command in a global format. The Xin port receives read data in the global format, and the global command as it propagates through all the composite memory devices.

As herein used, “global format” refers to a format compatible with the memory controller 1202 and bridge devices 1212, and similarly “global command” refers to a command to be interpreted in at least one of the bridge devices 1212. “Local format” refers to a format compatible with the discrete memory devices 1214 and the bridge devices 1212, and similarly “local command” refers to a command to be interpreted in at least one of the discrete memory devices 1214. Each of the composite memory devices shown in FIG. 12 has one bridge device 1212 and four discrete memory devices 1214 (the illustrated 1:4 relation is just by way of example, and other relations such as 1:2, 1:8, or any suitable relation is contemplated). Each bridge device 1212 in each of the composite memory devices is connected to respective discrete memory devices 1214, and to either the memory controller 1202 and/or a previous or subsequent composite memory device in the ring of devices. Each of the bridge devices 1212 is able to process a packet containing a global command intended for it and, based on the information contained in that packet, provide a local command to at least one of its respective discrete memory devices 1214. Based on the above description, other functions of the bridge devices 1212 should be understood to those skilled in the art. For example, it will be understood that read data stored in a memory array of any of the memory devices 1214 can be transmitted out from that memory device, received by a respective bridge device 1212, and then communicated around the ring of devices back to the memory controller 1202. In some examples, each of the discrete memory devices 1214 comprises more than one plane (for example, two planes). As will be appreciated by those skilled in the art, each plane may individually equate to one Logical Unit Number (LUN).

Any one of various systems having memory devices, including any one of those diagrammatically shown in FIGS. 2, 3 and 12, can implement status indication in any manner previous herein described, whether it be of the asynchronous-type or of the synchronous-type. It will thus be seen that the number of contemplated example embodiments is numerous.

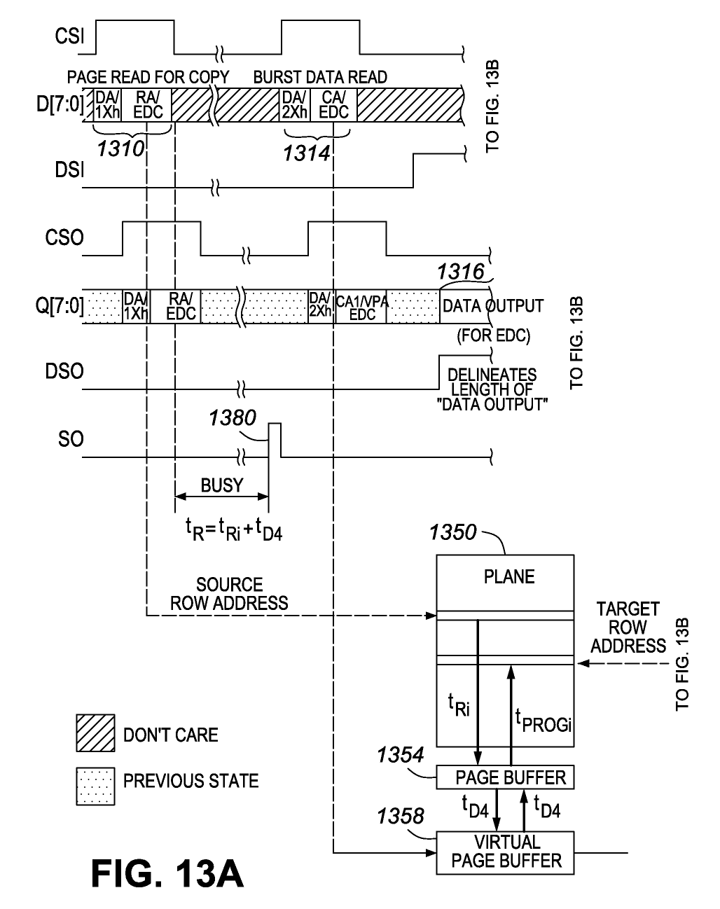

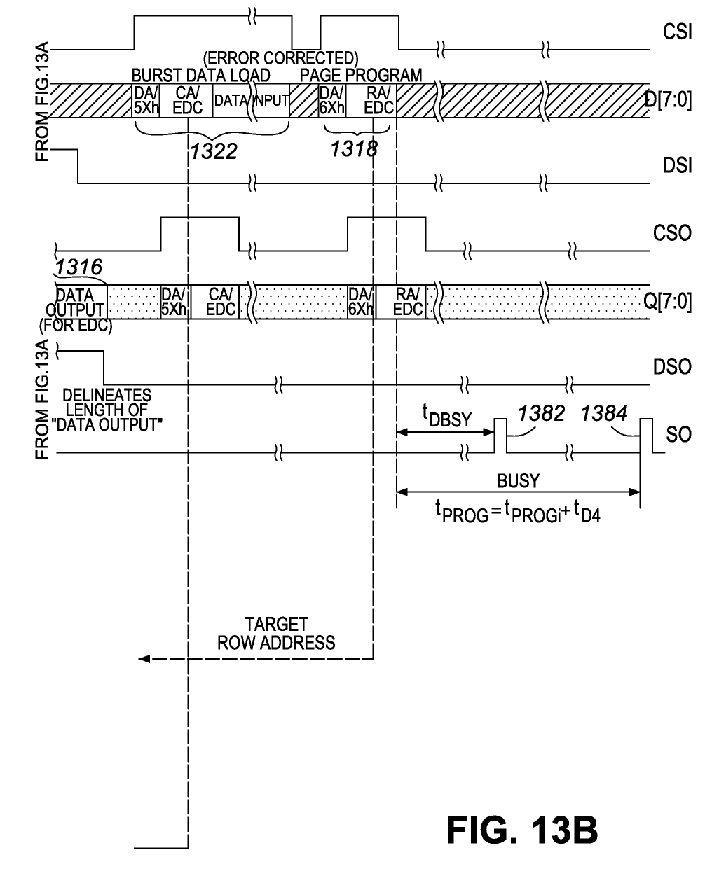

Reference will now be made to FIGS. 13A and 13B. FIGS. 13A and 13B are a timing diagram showing status indication, in conjunction with a page copy operation, within the system 1200 of FIG. 12. The illustrated page copy operation may be used to quickly and efficiently transfer data stored in one page of a bank to another page in the same bank without reloading data (assuming there is no bit error in the stored data). The page copy operation may be particularly useful for so called “garbage collection”, where the memory array is defragmented to optimize the allocation of the storage resources. In the page copy operation, the following is the sequence of commands: 1) Page Read for Copy (DA & 1Xh) command (denoted by reference numeral 1310) is issued first; 2) After the page read time (denoted in the timing diagram by t_{R}, and meaning the time for a page to be “read” from a plane into a virtual page buffer), a Burst Data Read (DA & 2Xh) command (denoted by reference numeral 1314) is issued in order to check bit error by sequential reading out the data (denoted by reference numeral 1316); and 3) If no bit error is detected, Page Program (DA & 6Xh) command (denoted by reference numeral 1318) is then issued in order to start page copy programming. If however a bit error is detected, then there is another command, between the Burst Data Read (DA & 2Xh) command and the Page Program (DA & 6Xh) command, issued along with the column address and the data to be modified:

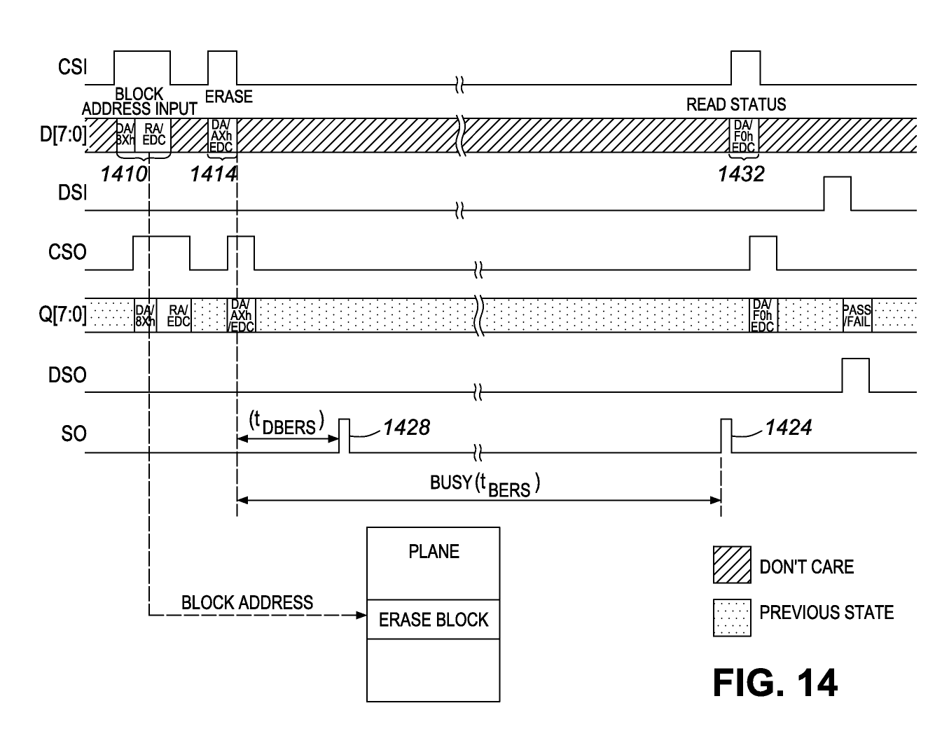

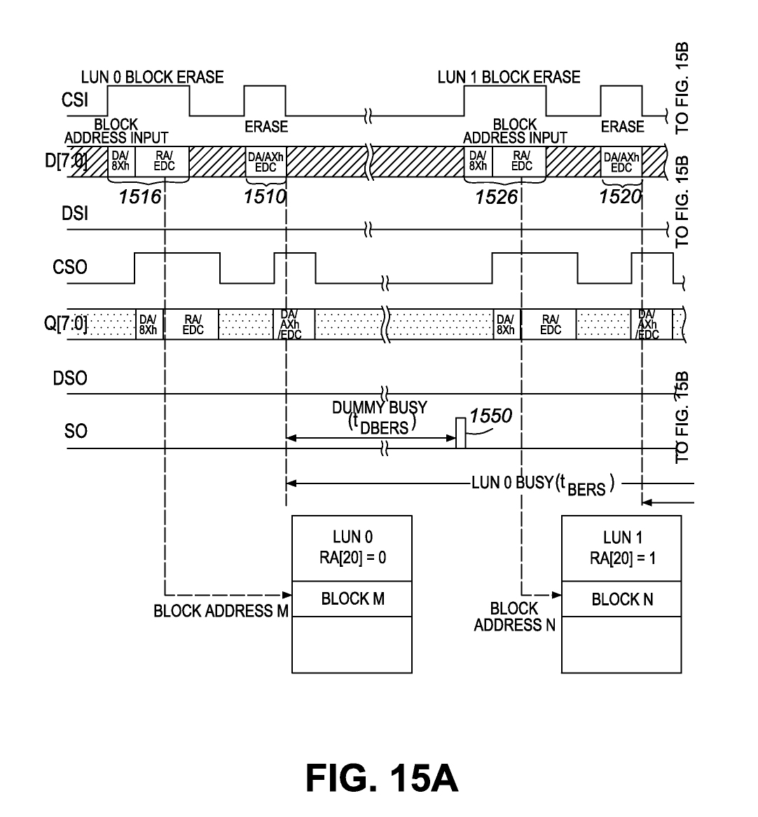

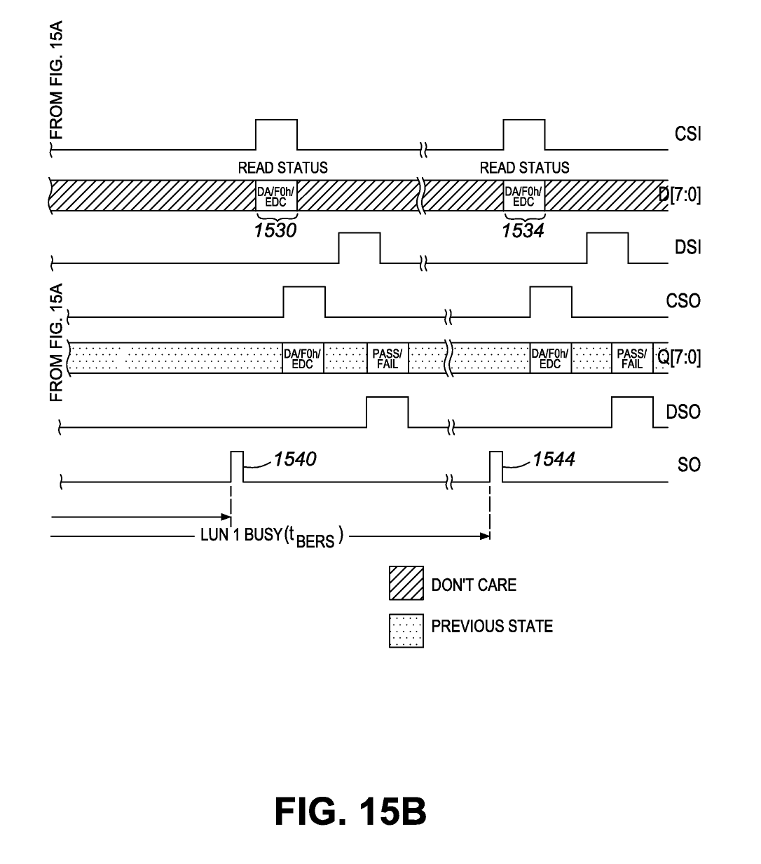

Burst Data Load (DA & 5Xh) command (denoted by reference numeral 1322). The Burst Data Load command is for modifying the copied data if a bit error is detected. Also, it is worth mentioning again that command types shown in FIGS. 13A and 13B (for example, 1Xh, 2Xh, etc.) are just by way of example, and that any other suitable bytes for these are certainly contemplated. Furthermore the same comment applies in connection with later descriptions provided in relation subsequent FIGS. 14 and 15.

To further assist in understanding the page copy operation, a sub-diagram is embedded within the timing diagram (FIG. 13A). Referring to this sub-diagram, memory plane 1350 and page buffer 1354 are within one of the discrete memory device 1214 (FIG. 12). Virtual page buffer 1358 is in the respective bridge device 1212. The Virtual page buffer 1358 is a temporary storage. Part of the function of the Virtual page buffer 1358 is to provide an intermediate storage for data destined for or data being provided out from one of the composite memory devices 1204-1 to 1204-N. In some examples, the Virtual page buffer 1358 comprises Static Random Access Memory (SRAM). Also, the sub-diagram of FIG. 13A includes self-explanatory arrows (solid and non-solid) and labeling.

Still with reference to FIGS. 13A and 13B, a number of single strobe pulse 1380, 1382 and 1384 are each intended to provide an indication of some form of status change within one of the memory devices 1212 (FIG. 12). More specifically, the strobe pulse 1380 provides, following some period of time after the Page Read for Copy command 1310 has been received by the memory device 1212, indication of completion of transfer of a page stored in the memory plane 1350 into the Virtual page buffer 1358. The strobe pulse 1382 provides, following some period of time after the Page Program command 1318 has been received by the memory device 1212, indication of the memory device 1212 no longer being busy in connection with the Page Program command 1318 (i.e. the memory device 1212 now being able to receive a next command). The strobe pulse 1384 provides, following some period of time after the Page Program command 1318 has been received by the memory device 1212, indication of completion of the page program operation.

Reference will now be made to FIG. 14. FIG. 14 is a timing diagram showing status indication, in conjunction with a block erase operation, within the system 1200 of FIG. 12. In accordance with the illustrated block erase operation, first a Block Address Input (DA & 8Xh) command is loaded along with three bytes of row address for selection of block to be erased (both denoted collectively by reference numeral 1410). When all address information for the block to be erased is loaded, the Erase (DA & AXh) command (denoted by reference numeral 1414) is issued to start the internal erase operation for the selected block. An internal erase state machine may be employed to automatically execute a proper algorithm, and for controlling all the necessary timing for the operation including verification.

The memory controller 1202 (FIG. 12) can detect the completion of the erase operation (after a period of time denoted in the timing diagram by t_{BERS}) by monitoring for receipt of a strobe pulse 1424. Also, for clarification purposes, there are two status strobe pulses shown in FIG. 14: strobe pulse 1428 and the strobe pulse 1424; however the strobe pulse 1428 is issued by one of the memory devices 1212 earlier in time. The strobe pulse 1428 provides, following some period of time after the Erase command 1414 has been received by the memory device 1212, indication of the memory device 1212 no longer being busy in connection with the Erase command 1414. In other words, the status change corresponding to strobe pulse 1428 is the memory device 1212 being now able to receive any next command intended for another one of the four discrete memory devices 1214 connected to the memory device 1212.

Upon receiving the strobe pulse 1424, the memory controller 1202 can issue the Read Status Register (DA & F0h) command (denoted by reference numeral 1432) in order to check pass/fail results for the bank or LUN of the discrete memory device 1214 in which the erase operation is carried out. In some examples, a status register of at least three bytes can be read during the device operation. A first status register byte may represent the first LUN of the bank, and a second status register byte may represent the second LUN of the bank. Certain bits of the status register may reflect the status (i.e., busy or ready) of each bank. When the bank becomes ready, certain additional bits may indicate whether each bank operation is passed or failed. If a particular Status Register bit indicates a ‘Pass’ result, the specified block is successfully erased. However if that Status Register bit indicates a ‘Fail’ result, the specified block is not erased successfully. In this case, the failed block would be mapped out as a ‘bad’ block.

Reference will now be made to FIGS. 15A and 15B. FIGS. 15A and 15B are a timing diagram showing status indication, in conjunction two concurrent operations carried out in connection with two LUNs, within the system 1200 of FIG. 12. In accordance with this example embodiment, two concurrent operations for two LUNs can be performed as shown in FIGS. 15A and 15B, as each bank consists of two separate LUNs controlled by the Most Significant Bit (MSB) of row address (for example, RA[20] or some other suitable bit). Once a first LUN receives an Erase (DA & AXh) command (denoted by reference numeral 1510, and that follows the previously explained Block Address Input command and three bytes of row address that are both denoted collectively by reference numeral 1516) the first LUN enters into a busy state for a period time (i.e. t_{BERS}) and also a second LUN enters into busy state for a shorter period time (i.e. t_{DBERS}). From a practical perspective, the t_{DBERS} period can be viewed as the period during which the bus between the memory device 1212 (FIG. 12) and the respective discrete memory device 1214 is busy. After t_{DBERS}, this bus is no longer busy (as indicated by strobe pulse 1550) and the second LUN becomes ready for another operation such as, for example, page program, block erase or page read. In this example embodiment, the second Erase (DA & AXh) command and corresponding Block Address Input command and three bytes of row address are denoted by reference numerals 1520 and 1526 respectively. Combining the two-plane operation, two-LUN operation and concurrent multi-bank operation can be implemented in order to improve overall system performance.

Also shown in FIG. 15B are the Read Status Register (DA & F0h) command for the first LUN (denoted by reference numeral 1530) and the Read Status Register (DA & F0h) command for the second LUN (denoted by reference numeral 1534). The Read Status Register (DA & F0h) command was previously explained in connection with FIG. 14. Also as explained in more detail previously, strobe pulse 1540 precedes issuance of the Read Status Register command 1530, and strobe pulse 1544 precedes issuance of the Read Status Register command 1534. The strobe pulse 1550 provides indication of the memory device 1212 being now able to receive the next Erase command 1520 to the “ready” LUN.

At least some example embodiments herein described can be applied to any suitable solid state memory systems such as, for example, those that include NAND Flash EEPROM device(s), NOR Flash EEPROM device(s), AND Flash EEPROM device(s), DiNOR Flash EEPROM device(s), Serial Flash EEPROM device(s), DRAM device(s), SRAM device(s), Ferro RAM device(s), Magnetic RAM device(s), Phase Change RAM device(s), or any suitable combination of these devices.

Although some example embodiments herein shown and described relate to a system having a point-to-point ring topology, because there is a series-interconnection configuration that exists between a controller device of the system and a plurality of semiconductor memory devices of the system, it will be understood that some alternative example embodiments relate to other types of systems such as, for example, those that would be characterized as being a multi-drop system.

It will be understood that when an element is herein referred to as being “connected” or “coupled” to another element, it can be directly connected or coupled to the other element or intervening elements may be present. In contrast, when an element is herein referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Certain adaptations and modifications of the described embodiments can be made. Therefore, the above discussed embodiments are considered to be illustrative and not restrictive.

1. A system comprising:
a plurality of devices, each of the plurality of devices including a status input pin, a status output pin, and separate data input and output pins, and the plurality of devices including:
a) a plurality of semiconductor memory devices including at least first and last memory devices; and
b) a controller device for communicating with the semiconductor memory devices, and
the first memory device having a status input pin connected to a status output pin of the controller device, a status output pin of the first memory device being connected to a status input pin of either an intervening memory device or the last memory device, the status input pin of the last memory device being connected to a status output pin of either another intervening memory device, the intervening memory device or the first memory device, and a status output pin of the last memory device being connected to a status input pin of the controller device so that a status ring is formed, and each of the plurality of devices being on the status ring, and the status ring providing a status communications path that is independent of any data communications path between any of the semiconductor memory devices and the controller device.

2. The system of claim L wherein at least one of the semiconductor memory devices is configured to output a status packet onto the status ring to provide indication of a status change within the at least one of the semiconductor memory devices.

3. The system of claim 2, wherein the status packet includes identification bits for identifying that the status packet originated from the at least one of the semiconductor memory devices.

4. The system of claim 1, wherein at least one of the semiconductor memory devices is configured to output a single strobe pulse onto the status ring to provide indication of a status change within the at least one of the semiconductor memory devices.

5. The system of claim 1, wherein at least one of the semiconductor memory devices includes at least one data output pin for outputting data in synchronous relation to edges of a clock signal.

6. The system of claim 5, further comprising at least two asynchronous flash memory devices, the asynchronous flash memory devices being connected to the at least one of the semiconductor memory devices, and wherein the at least one of the semiconductor memory devices is a bridge device that is configured to communicate asynchronously with either of the at least two asynchronous flash memory devices.

7. The system of claim 6, wherein the at least one of the semiconductor memory devices is configured to output a status packet onto the status ring to provide indication of a status change within the at least one of the semiconductor memory devices.

8. The system of claim 7, wherein the status packet include identification bits for identifying that the status packet originated from the at least one of the semiconductor memory devices.

9. The system of claim 6, wherein the at least one of the semiconductor memory devices is configured to output a single strobe pulse onto the status ring to provide indication of a status change within the at least one of the memory devices.

10. The system of claim 1, wherein the plurality of semiconductor memory devices are flash memory devices.

11. The system of claim 1, wherein the flash memory devices are NAND flash memory devices.

12. A memory device comprising:
a plurality of data pins for connection to a data bus;
a status pin for connection to a status line that is independent from the data bus;
first circuitry for generating, upon completion of a memory operation having a first duration, a strobe pulse of a second duration much shorter than the first duration, and the strobe pulse providing an indication of the completion of the memory operation; and
second circuitry for outputting the strobe pulse onto the status line via the status pin.

13. The memory device of claim 12, wherein the memory device is a bridge device configured for connection to a plurality of discrete memory devices.

14. The memory device of claim 13, wherein the memory operation is a memory operation in one of the discrete memory devices.

15. The memory device of claim 14, wherein the plurality of discrete memory devices are flash memory devices, and the memory operation consists of one of program, read and erase.

16. The memory device of claim 15, wherein the flash memory devices are NAND flash memory devices.

17. The memory device of claim 13, wherein the bridge device is configured to communicate with both: i) a controller device in a ring-type topology system; and ii) the plurality of discrete memory devices in a multi-drop subsystem.

18. A method comprising:
providing a flash memory device comprising a plurality of data pins and a status pin, the plurality of data pins connected to a data bus, and the status pin connected to a status line that is independent from the data bus;
carrying out, within the flash memory device, a memory operation having a first duration;
generating, upon completion of the memory operation, a strobe pulse of a second duration much shorter than the first duration, and the strobe pulse providing an indication of the completion of the memory operation; and
outputting the strobe pulse onto the status line via the status pin.

19. The method of claim 18, wherein the memory operation consists of one of program, read and erase.

20. The method of claim 18, wherein the flash memory device is a NAND flash memory device.

21. A memory device comprising:
at least one data input pin;
at least one data output pin;
a status input pin configured for connection to a status output pin of either another memory device or a controller device; and
a status output pin configured for connection to a status input pin of either yet another memory device or the controller device, and
wherein the status input pin of the memory device, the status output pin of the memory device, the at least one data input pin and the at least one data output pin are each physically distinct pins from one another.

22. The memory device of claim 21, wherein the memory device is a flash memory device configured to carry out, within the flash memory device, a memory operation having a first duration.

23. The memory device of claim 22, wherein the flash memory device is further configured to generate, upon completion of the memory operation, a strobe pulse of a second duration much shorter than the first duration, and the strobe pulse providing an indication of the completion of the memory operation.

24. The memory device of claim 23, wherein the flash memory device is further configured to output the strobe pulse via the status output pin.

25. The memory device of claim 22, wherein the memory operation consists of one of program, read and erase.

26. The memory device of claim 21, wherein the memory device is a bridge device configured for connection to a plurality of discrete memory devices, and the bridge device is configured to communicate with both: i) the controller device in a ring-type topology system; and ii) the plurality of discrete memory devices in a multi-drop subsystem.
